(19) United States
(12) Patent Application Publication
(10) Pub. No.: US 2003/0164876 A1
(43) Pub. Date: Sep. 4, 2003

(54) Procedure and device for measuring positions of continuous sheets

(76) Inventor: Frank Pierel, Kiel (DE)

Correspondence Address: Lawrence P. Kessler, Patent Department, NexPress Solutions LLC, 1447 St. Paul Street, Rochester, NY, 14653-7103, US

(21) Appl. No.: 10/097,396

(22) Filed: Mar. 14, 2002

(30) Foreign Application Priority Data
Apr. 14, 2001 (DE) 101 18 556.1

(51) Int. Cl. H04N 7/18

(52) U.S. Cl. 348/88; 348/95

(57) ABSTRACT

A device and procedure for measuring the positions of sheets for a printing press by precisely determining and then correcting the positioning of sheets in a printing press. Edge areas of a sheet are reproduced, imaging data are transferred to a computer and the positioning of the sheet is detected on the basis of the imaging data by means of an image detection algorithm. Furthermore, the positions of the sheet determined are compared with the stored positions in the computer and position deviations are calculated from the comparison, which are transferred to the printing press and corrected by a sheet-registering device.

### FIELD OF THE INVENTION

The invention relates to a procedure and a device for measuring the positions of sheets for a printing press.

### BACKGROUND OF THE INVENTION

In the printing industry, a variety of printing presses are used with various paper paths, i.e., the manner varies in which the sheets as stock travel in the printing press. One problem with the conveying of the sheets is their correct orientation and location, which must be ensured, particularly during printing. Here, orientation is understood to mean the angular alignment of the sheets and location is understood to mean the vertical and horizontal position of the sheets. Here, the term positioning includes both of the terms orientation and location. Thus, all points in the two-dimensional space can be described with the term the position/positioning.

An incorrect positioning of the sheets leads to defects in the printing image, particularly during the multicolor printing process, in which several color separations are printed, one on top of the other. The correct positioning of the stacked printing of the color separations determines the sharpness of the imprint and is one of the most important characteristics of the printing quality. Furthermore, an incorrect positioning of the sheets during printing leads to displacements of the entire image to be printed, which is customarily composed of several color separations.

In order to guarantee the correct orientation and location or the positioning of the sheets in the printing press, various solutions have been suggested. A customary state-of-the art procedure is the use of various measuring marks of various sizes as register marks, which are applied to the sheets or to a conveyor belt. By these register marks, the position of the sheets can be determined in many ways, e.g., by a sensor, which, for example, determines the edges of the register marks and from them the position of the sheets. The disadvantage of this solution is obviously the costly application of the register marks to the sheets.

With another suggested solution, the printing press uses CCD (charge-coupled device) lines to determine positions, which determine the leading edges and lateral edges of the sheets. This suggested solution has disadvantages, since the edges of the sheets as a rule are not properly developed, and, as a result, the measurements are distorted.

### SUMMARY OF THE INVENTION

Thus the task of the invention is to provide a procedure and a device that can determine the positions of the stock exactly. For the solution according to the invention, edge areas of sheets are reproduced, and the subsequent imaging data are transferred to a computer and the position of the sheets is determined on the basis of the imaging data by an image detection algorithm. To produce an automatic correction procedure, the positions of the sheet are compared with positions stored in the computer and position deviations are calculated on the basis of the comparison procedure, then the position deviations are transferred to the printing press, and corrected by a sheet-registering device.

Preferably, at least two digital cameras are used, which are equipped with the CCD (Charge-Coupled Device) technology. When this procedure is applied, the digital imaging data can be used directly by the computer. The positions of the imaged sheets can be determined already using the imaging data of the sheet corners. This means that the positions can already be calculated by determining the x-y coordinates of two points, using the imaging data available in a coordinate system in the computer. To increase the measuring sensitivity, the individual sheet edges are reproduced several times and evaluated and subsequently, mean values are determined from the imaging data contained therein.

Preferably, the image detection algorithm in the computer detects sections from the edge areas of an image on the edge of sheets, i.e., on the transfer of the sheets to the sheet carrier, and from these sections, it determines the position of the sheets. This makes it possible to determine the position of the sheets with little computer effort.

The invention, and its objects and advantages, will become more apparent in the detailed description of the preferred embodiment presented below.

### BRIEF DESCRIPTION OF THE DRAWINGS

In the detailed description of the preferred embodiment of this invention presented below, reference is made to the accompanying drawings in which:

FIG. 1 is a schematic top view of a sheet on the conveyor belt and shows two cameras forming part of an imaging device;

FIG. 2 is an illustration similar to FIG. 1, whereby the sheet has position deviations; and

FIG. 3 is an illustration similar to FIG. 2 with a block diagram of a computer and a screen.

### DETAILED DESCRIPTION OF THE INVENTION

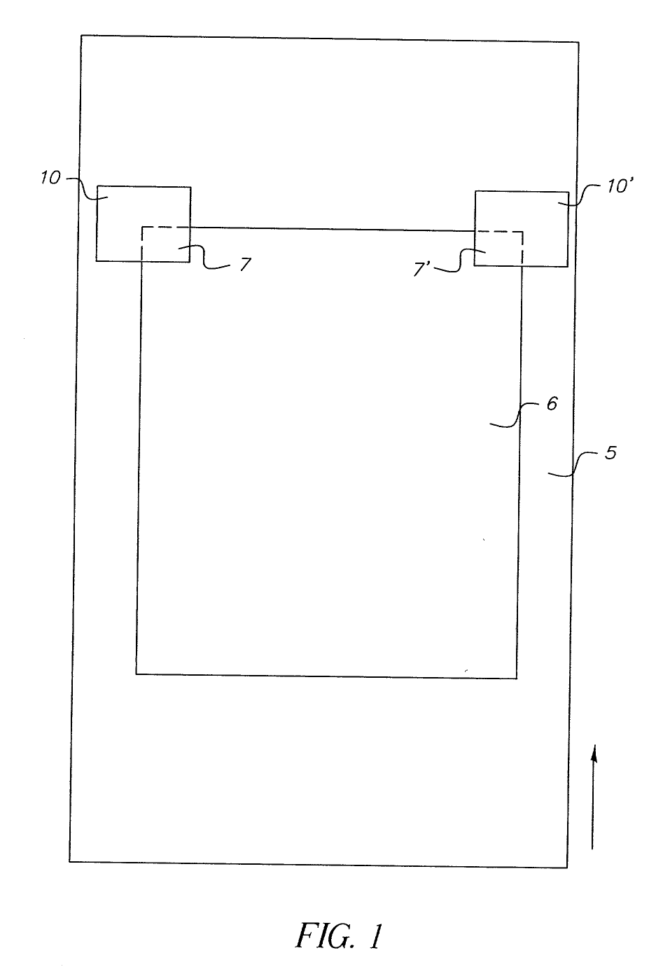

The top view in FIG. 1 shows a section of a continuous conveyor belt 5, as is customarily used in printing presses. The conveyor belt 5 is driven and moves in the direction indicated by the directional arrow. A typical speed of sheet 6 is 300 mm per second. A single sheet 6 of stock to be printed is located on the conveyor belt 5. The sheet is basically held on the conveyor belt 5 by electrostatic charges applied to the conveyor belt 5, which produce electrostatic forces on the conveyor belt as the belt moves through the printing press with the sheet. Above the conveyor belt 5 and the sheet 6 are two digital cameras 10, 10′, which are arranged as part of the imaging device on the edge area of sheet 6. The microchips of the cameras 10, 10′ preferably use the CCD (Charge-Coupled Device) technology.

The shutter speed of the cameras 10, 10′ may be 1/100 000 s. The short shutter speed of the cameras 10, 10′ is required if a high measuring sensitivity is to be achieved. The longer the shutter speed of the cameras 10, 10′ is, the further sheet 6 will move with the conveyor belt 5 during the taking of the picture or the image, and will thus degrade the measuring results, since the temporal allocation of the picture or image of the sheet 6 is based on the position measurement of sheet 6. The lenses of the camera 10, 10′ are directed vertically in the line of sight in the direction of sheet 6 lying on conveyor belt 5.

In this view, the edge areas 7, 7′ of the sheet 6 hidden to the cameras 10, 10′ are shown in FIG. 1 with dotted lines. With the help of a trigger signal from a control device (not shown) of the imaging device, the cameras 10, 10′ are activated at the point in time when the edge areas 7, 7′ of the sheet 6 are below the cameras 10, 10′ in their picture-taking area. The images of the edge areas 7, 7′ of sheet 6 provide digital data, which are indicated hereby as imaging data. The imaging data obtained are further processed, as described below. FIG. 1 illustrates the case in which sheet 6 has no position deviations, i.e., sheet 6 is located in the desired orientation and location and has not been displaced in the in-track or in the cross-track direction with respect to conveyor belt 5. The images of the edge areas 7, 7′, which correspond approximately to the outlines of the cameras 10, 10′ illustrated in FIG. 1, indicate mirror symmetrical images of the edge areas 7 and 7′, whereby the lateral edges and the leading edge of sheet 6 extend parallel to the lateral or upper edge of the picture area of the cameras 10, 10′.

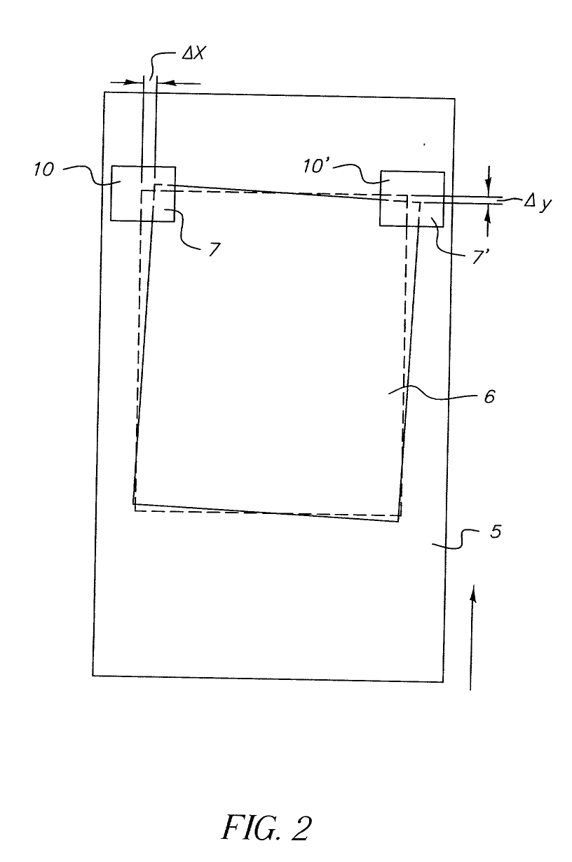

FIG. 2 illustrates the case in which sheet 6 has undesired deviations in in-track and cross-track directions Δy or Δx to the line of sight due to an angular displacement. Using the Δy and Δx values, the angle in which sheet 6 has been displaced in comparison with the flawless position illustrated by the dotted rectangle, can be determined in the computer by simple geometric operations. The processing of this image is identical to the description for FIG. 1. However, as is evident, these images have changed in comparison with FIG. 1, and, as a result, the digital imaging data obtained are also different. The presence of the position deviations of sheet 6 shown in FIG. 2 leads to defects in subsequent printing processes and must therefore be corrected.

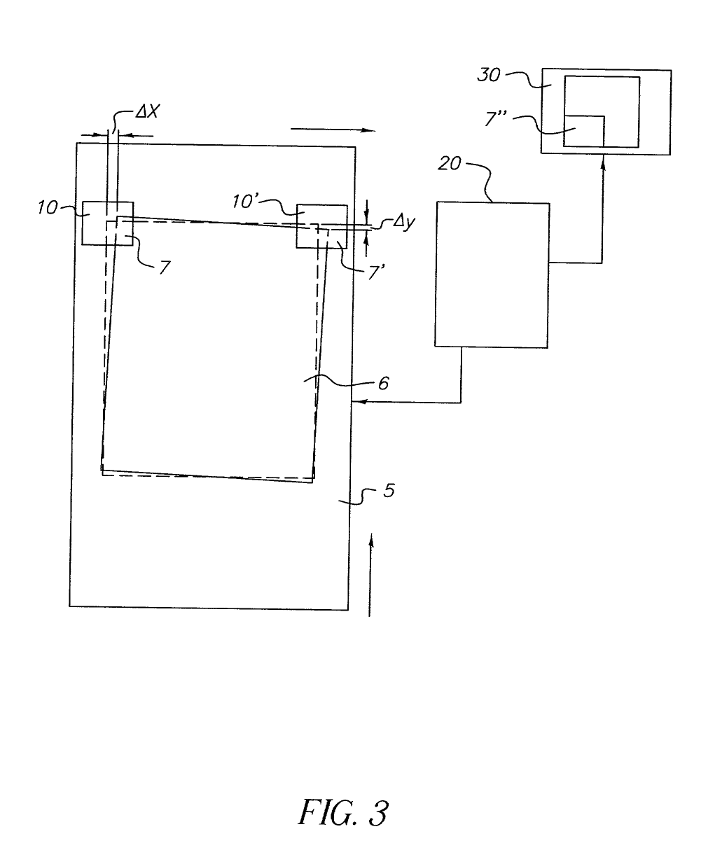

In order to explain the procedure for measuring positions and correcting position deviations, the schematic drawing according to FIG. 3 is described below, in which, as can be seen, a position deviation occurred as shown in FIG. 2. As above, sheet 6 is transported on conveyor belt 5 in the direction of the arrows and the edge areas 7, 7′ were reproduced by a trigger signal from the cameras 10, 10′. The digital imaging data are transferred by the cameras 10, 10′ via a connection to computer 20. An image detection algorithm is provided in computer 20, in which the imaging data can be analyzed. For example, the light/dark transmission of the sheet 6 to the conveyor belt 5 is captured during this process. Primarily for illustration purposes, a screen 30 is connected to computer 20 in FIG. 3, on which, for example, the imaging data that are transferred from camera 10′ of edge area 7′ of sheet 6 are indicated as image 7″. Screen 30 has no bearing on the invention. With the image detection algorithm, the sheet corners of the edge areas 7, 7′, i.e., the furthest point on sheet 6 that can still be recorded by the computer at that time with the given resolution, are determined as image points. The image detection algorithm produces an image point for each image reproduced and edge area 7 and 7′, and the image points of the two simultaneously reproduced edge areas 7 and 7′ clearly determine the orientation and location of sheet 6. In comparison to the state-of-the-art procedure, in which the sheet edges are detected with sensors, the determination of the sheet corners always provides the geometrically clear position of sheet 6. By comparing the images detected with the image detection algorithm to the known stored set coordinates of the image points, it can be determined by what angle position and by what length in the in-track and cross-track direction sheet 6 has been displaced. These displacements can be determined and corrected up to the micrometer range. Therefore, by a subsequent correction procedure, the flawless positioning on conveyor belt 5 can be guaranteed. Computer 10 gives the correcting values it established from the predetermined image points and actual image points to a control device (not shown) of the printing press, which carries out a correction of the printing cylinder or a sheet path correction using servos via a control device.

In particular, the use of an image detection algorithm, in addition to the detection of image points of image points of the edge areas 7, 7′ of sheet 6, allows further variations of the steps for determining the position of sheet 6. The image can detect sheet 6 in its entirety; in this manner, it can be determined whether the shape of the sheet is defective, i.e., for example, whether the edge areas 7, 7′ of sheet 6 are damaged or nicked. With the help of the image detection algorithm, these facts are then taken into account during the calculation of the correction values. If, for example, a sheet section of an edge area 7, 7′ is missing in the image because sheet 6 has been nicked, the image detection algorithm interpolates the missing sheet section and determines the correct image point of the corner edge of the edge area 7, 7′, i.e., each sheet corner has an x-y coordinate. Furthermore, various sheets 6 show the same format of other deviating measurements, i.e., the lengths, corner edges and corner angles of sheet 6 cannot be obtained to the precise micrometer. For example, the DIN allows length tolerance deviations of 2 mm in the DIN 476 format. These high tolerance values are often erroneously detected as position deviations, using the customary procedure for measuring positions. By detecting the entire sheet 6 by the imaging device or by determining the edge areas 7, 7′, computer 20 recognizes a sheet 6 by the measurements of sheet 6 that deviate from the imaging data, however, it does not misinterpret this as position deviations and does not correct them by the sheet registering device. The procedure and the device for measuring positions are described for the continuous sheet 6, and the measurement is done with the sheet moving. In addition, this disclosure requires the stopping of the continuous sheet 6 and the measuring of the unmoving sheet 6 in that position.

The invention has been described in detail with particular reference to certain preferred embodiments thereof, but it will be understood that variations and modifications can be effected within the spirit and scope of the invention.

What is claimed is:

1. Procedure for measuring positions of a continuous sheet (6) with an image detection device creating at least a partial image of the image area of a sheet (6), characterized by the respective creation of images of the edge areas (7,7′) of a sheet (6), transferred to a computer (20) by the imaging data produced by the imaging process, and determining the positions of sheet (6) on the basis of the imaging data by an image detection algorithm.

2. Procedure for measuring positions of the continuous sheet (6) according to claim 1, characterized by a comparison of the positions of sheet (6) determined with stored positions in the computer (20), calculation of position deviations from the comparison procedure, transfer of the position deviations to the printing press and correction of the position deviations by a sheet-registering device.

3. Procedure for measuring positions of continuous sheet (6) according to claim 2, characterized by the determination of the positions of the imaged sheet (6) by the sheet corners determined from the imaging data.

4. Procedure for measuring positions of continuous sheet (6) according to claim 2, characterized by the creation of several images of individual edge areas (7, 7′) of the sheet (6) conveyed by the printing press and images of mean values from the imaging data in the computer (20).

5. Procedure for measuring positions of continuous sheet (6) according to claim 2, characterized by the determination of sections from the edge areas (7, 7′), an image produced by computer (20), and the determination of the positions of sheet (6) on the basis of the sections of the imaging data by an image detection algorithm.

6. Device for measuring the positions of a continuous sheet (6) for a printing press or a copier with an imaging device for images of the sheet (6), characterized by a computer (20) for the evaluation of the images of the imaging device.

7. Device for measuring the positions of a continuous sheet (6) according to claim 6, characterized in that the imaging device contains at least two CCD cameras (10, 10′).

8. Device for measuring the positions of a continuous sheet (6) according to claim 6, characterized in that computer (20) contains an image detection algorithm.
